(19) United States
(12) Patent Application Publication
(10) Pub. No.: US 2017/0228794 A1
(43) Pub. Date: Aug. 10, 2017

(54) ONLINE ADVERTISING E-CPM GOAL WITH IMPROVED FILL RATE

(71) Applicant: Pubmatic, Inc., Redwood City, CA (US)

(72) Inventors: Anand DAS, Sunnyvale, CA (US); Rajeev Kumar GOEL, Menlo PArk, CA (US); Rohan BANKAR, Pune (IN)

(21) Appl. No.: 15/496,725

(22) Filed: Apr. 25, 2017

Related U.S. Application Data
(63) Continuation of application No. 14/701,239, filed on Apr. 30, 2015, now abandoned.
Application No. 14/701,239 is a continuation of application No. 14/276,658, filed on May 13, 2014.

(51) Int. Cl. G06Q 30/02

(52) U.S. Cl. CPC G06Q 30/0275; G06Q 30/0269; G06Q 30/0261; G06Q 30/0277

(57) ABSTRACT

Ad segments on a Web page are filled with ads that are served by a service provider operating between a user computer and publisher on one end and multiple ad serving entities on the other. The service provider implements a bidding process for the ad segment. The winning ad serving entity (DSP, ATD, advertiser, etc.) has its ad delivered to the user browser by the service provider where it is displayed in the Web page. Rules are provided that define conditions for accepting bids below a goal e-CPM. Bids are filtered out if they would reduce an average e-CPM below the goal e-CPM. Additionally, bids may be filtered out based on a minimum floor e-CPM.

### CROSS REFERENCE TO RELATED APPLICATIONS

This application is a continuation of U.S. application Ser. No. 14/701,239, filed Apr. 30, 2015, which is a continuation of U.S. application Ser. No. 14/276,658, filed May 13, 2014.

### TECHNICAL FIELD OF THE INVENTION

The present invention relates generally to computer software and Internet advertising. More specifically, the invention relates to software for serving advertisements over the Internet for display on Web sites.

### BACKGROUND OF THE INVENTION

The online advertising industry is growing increasingly sophisticated. As the number of display ads grows, driven mainly by more intelligent programmatic ad buying capabilities, the amount of control that publishers (entities who have an inventory of advertising space to sell) want with respect to selling this ad space inventory grew. And with it the value of the publisher's inventory rose as well. There is an increasing desire among publishers to carve out specific inventory buckets for their ad space inventory. On the advertiser side, advertisers are now increasingly particular about how much they will pay to place their ads on Web pages. Presently, prices for paying for ad space is based on fairly generic level controls, such as Web site traffic, location on Web page, visibility on page, and the like. The specific audience, that is, who would see the ad, does not play a role in determining the value of an ad space or segment.

It would be desirable to provide publishers with greater level of control in determining which ads are served to them for display based on a variety of demographic and other categories. Overall this would also be desirable for the advertisers and entities providing services to advertisers. Advertisers would like to be able to target a specific audience and have the flexibility of paying more or less for a given ad segment depending on who will see the ad. Additionally, it is desirable to achieve a desired goal effective Cost Per Mil (e-CPM) with a high fill rate.

### SUMMARY OF THE INVENTION

In one aspect of the preset invention, a method of serving an ad to an ad segment on a Web page being viewed by a user is described. The Web page is published by an online publisher, such as a blog site, online retail store, mobile application, or media company. The service provider acts an entity that operates between the publisher and user computer on one end and ad serving entities, such as demand side partners (DSPs), agency trading desks (ATDs), advertisers, and other entities in the ad industry that provide and deliver ads. Conventionally real time bids for an ad segment are not accepted if they are below a floor eCPM. An ad server implements rules to permit selecting real time bids for an ad segment that are below a goal e-CPM. In one embodiment bids are filtered out if they do not satisfy minimum floor e-CPM criteria associated with eCPM Goal. Additionally, bids may be filtered out if a result of accepting the bid would reduce an average e-CPM below a goal e-CPM. The minimum floor e-CPM may be adjusted over time based on different parameters, including time of day and supply and demand patterns. The rules may be selected to optimize fill rate and revenue.

### BRIEF DESCRIPTION OF THE DRAWINGS

The invention and the advantages thereof may best be understood by reference to the following description taken in conjunction with the accompanying drawings in which:

FIG. 1 is a block diagram showing the entities and relationships for controlling advertising and setting e-CPM floors in accordance with one embodiment of the present invention.;

FIG. 2 is a block diagram showing modules of a an server implementing the present invention; and

FIG. 3 is a flow diagram of a process of serving an ad to a Web browser when a user has downloaded a Web page in accordance with one embodiment of the present invention. and

### DETAILED DESCRIPTION OF THE INVENTION

The present invention is directed to an improved method and system for enabling a publisher to adaptively select individual bids below a goal e-CPM while maintaining an overall goal eCPM for a publisher. The present invention builds off of earlier online eCPM advertising technology described in commonly owned U.S. patent application Ser. No. 13/708,435, filed on Dec. 7, 2012, entitled “GRANULAR CONTROL APPLICATION FOR DELIVERING ONLINE ADVERTISING,” the contents of which are hereby incorporated by reference. Additional background information is described in commonly owed U.S. patent application Ser. No. 12/510,061, filed on Jul. 27, 2009, entitled “DYNAMIC SELECTION OF OPTIMAL ADVERTISING NETWORK” the contents of which are hereby incorporated by reference.

Methods and systems for enabling a publisher to set floor prices for e-CPMs (“effective cost per mil”) using granular controls are described in the various figures. As described above, publishers would like to have greater control in determining what types of ads are displayed on its Web pages using a variety of demographic, geographic and other categories. Advertisers want to be able to target specific audiences and have the flexibility of paying more or less for a given ad segment.

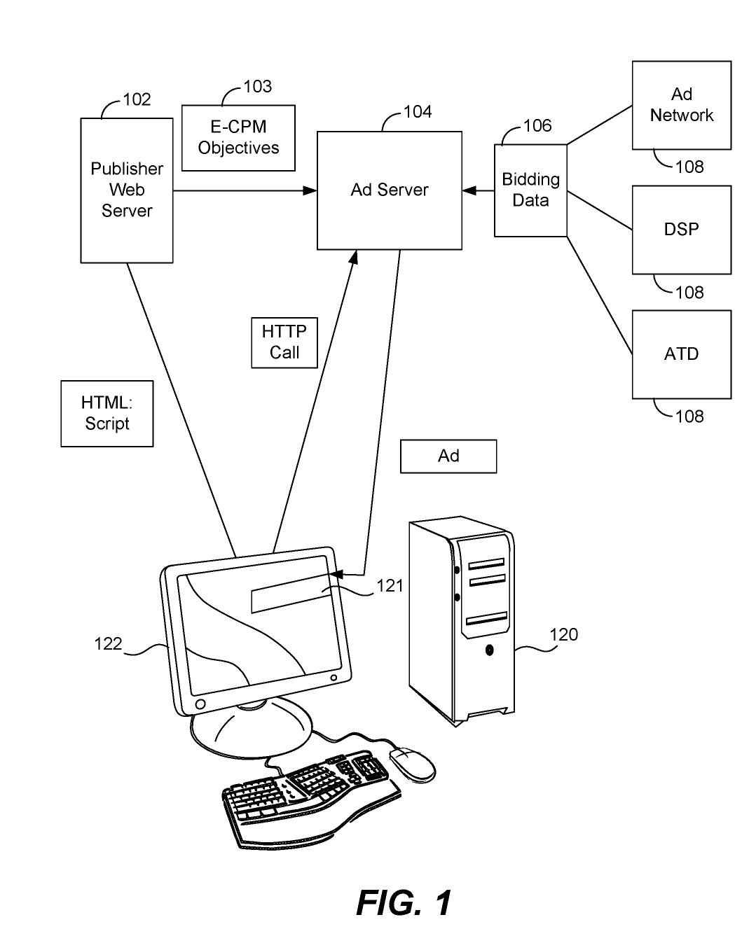

FIG. 1 is a block diagram showing the entities and relationships for controlling advertising and setting e-CPM objectives 103 in accordance with one embodiment of the present invention. At one end is a publisher 102, essentially a Web site that has advertising space or segments. A user viewing the website on a computer 120 receives an ad 121 on a page displayed on their user interface 122.

The publisher is in communication over the Internet with a third-party ad service provider 104 which operates one or more server computers that execute operations for implementing the present invention (the Internet is not shown; for illustrative purposes, lines are drawn directly between entities which may indicate direct communication or communication over the Internet). The ad service provider 104 is in communication with various ad network entities 108 (ad networks) that supply ads, such as demand side partners (DSP), ATDs, trading desks and advertisers, such as Ford, Proctor & Gamble, Coca-Cola etc. The ad service provider 104 communicates directly with these entities to auction ad segments. That is the ad service provider obtains real time bids 106 for ad segments (impressions). That is, when an individual user browses a web site, or any application on a device capable of computing and accessing the web, for example from a mobile device, tablet, SMART TV, Wearable Technology such as intelligent glasses, watches or anything else, the site includes ad tags for which real time bids may be taken to serve an impression. As examples, HTML script and HTML calls may be utilized, along with other known ad tagging techniques. For example, a user may visit a Web site and HTTP is downloaded to the user's browser where it is executed to render the Web site pages. In the HTTP there is a script for an ad which executes. The user computer may create an HTTP call which may contain a user ID and a session ID, retrievable from the user cookie or any other technique used to store user specific information. This HTTP call is then sent to a service provider computer.

The goal of the advertiser or advertising entities 108 is to serve online ads that reach as narrow and targeted an audience as possible; that is, ads that are most effective. In FIG. 1, there is communication between publisher 102 and service provider 104 and communication between service provider 104 and ad serving entities 108. Also illustrated are communications with a browser of the user's computer 120, which is a client machine having its own processor, memory and Input Output (IO) device.

In an embodiment of the present invention, a goal e-CPM may be established. That is, the goal e-CPM is a minimum average over many served impressions. For example, the publisher may want at least $2 e-CPM, on average, as a goal. This goal e-CPM may be defined over some relevant campaign definition, such as a period of time (e.g., one month). However, it will be understood that other campaign definitions may be used to define an average goal, such as an average e-CPM over a total number of impressions served. In an embodiment of the present invention, a minimum average goal objective may be set. However, as discussed below the ad server may adjust the short term e-CPM of acceptable winning bids to include bids below the goal e-CPM for objectives such as maximizing revenue or fill rate.

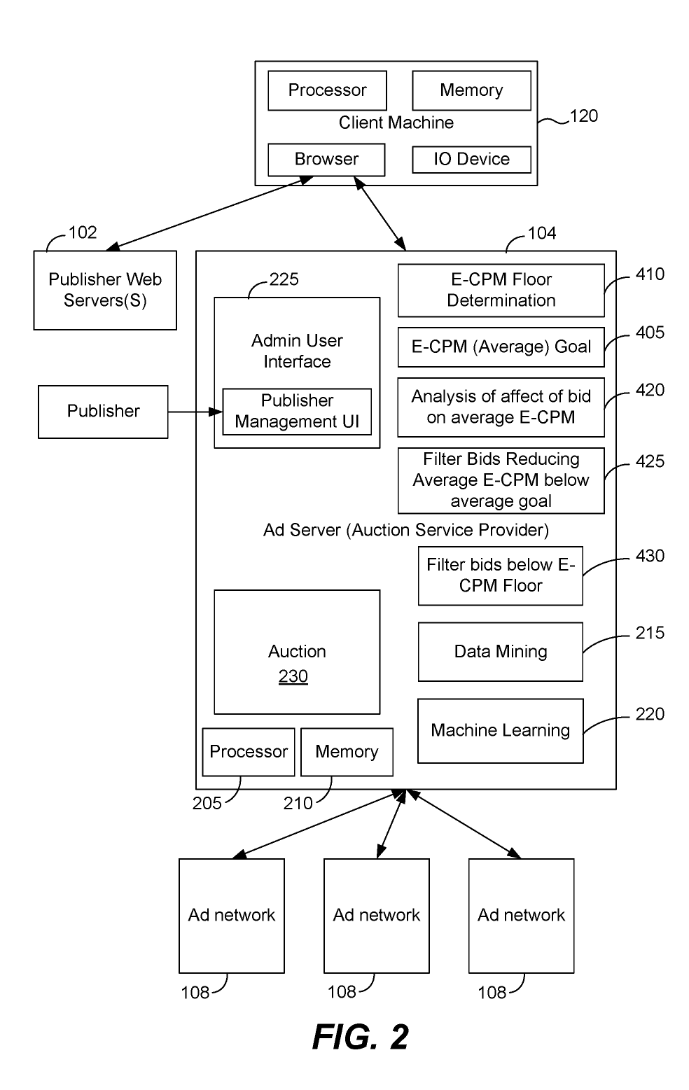

FIG. 2 is a block diagram showing in more details modules of the ad server 104 in accordance with an embodiment of the present invention. The ad server 104 includes hardware components, such as at least a processor 205 and a memory 210. Additionally the ad server 104 includes software modules to support an auction process. The ad server may include data mining 215 and machine learning 220 to analyze auction data. A publisher management UI 225 may be included as part of an admin user interface. An auction module 230 is provided to support a real time auction for individual ad segments to selected ad networks. For individual ads, the goal of publisher 102 is typically to obtain the highest e-CPM price for each of its advertising segments within the constraints of the rules of the particular auction method being employed. Over the course of a campaign many individual impressions are auctioned such that a publisher may desire a minimum average goal e-CPM.

An e-CPM goal module 405 defines a goal e-CPM that is an average for a campaign, which may, for example, be over a period of time (or number of impressions served). The publisher may set e-CPM goal objectives or factors. This may include an overall (minimum) goal e-CPM for a campaign. As examples, this may include an overall (minimum) goal e-CPM for a campaign OR a goal e-CPM across all campaigns/ad-networks. Moreover, the e-CPM goal objectives may also have goals based on factors based on targetable attributes such as geographic location of the user, user demographics, time of day, or number of impressions. For example, a goal e-CPM may be to achieve at least $2 e-CPM over the course of a one month campaign. It will also be understood that the goal e-CPM may be adjusted based on other factors, if desired.

An e-CPM floor price module 410 determines a minimum floor e-CPM. This floor price may be set by the publisher, either in a fixed manner or using one or more guidelines or factors. In theory a hard floor value could be selected. However, more generally the floor e-CPM price may also be based on targetable attributes such as geographic location of the user, user demographics, time of day, number of impressions, and supply and demand patterns. For example, the data mining module 215 and machine learning module 220 may be used to analyze data and determine supply and demand trends and then adjust the floor e-CPM. Additionally, a described in more detail later, in one embodiment this floor e-CPM price may be frequently adjusted based on supply and demand patterns. When bids arrive for an impression, a current e-CPM floor value is retrieved from the floor determination module 410 and used as one of the factors in filtering bids.

An average e-CPM analysis module 420 keeps track of the average e-CPM during the campaign and determines how an individual bid (if accepted) would alter the average e-CPM. Historical analysis of the average e-CPM is maintained during a campaign. Additionally, other data on the rate of change or predicted change may also be determined. For example, suppose that the minimum goal e-CPM is $2. However, if many bids exceeded this value in the past, then the average e-CPM may be higher than $2.00. For example, suppose that demand was high for some period of time in the past. The average e-CPM may be an average value of $2.50 due to a period of high demand. If a period of lower demands arrives, it may be possible that accepting an individual bid lower than the goal e-CPM will reduce the average e-CPM by a small amount but still be above the goal e-CPM.

In one embodiment a first bid filtering module 425 filters out bids that, if accepted, would reduce the average e-CPM below the goal e-CPM. Suppose, for example, that the average e-CPM is $2.50, that is, a number greater than a minimum $2 goal E-CPM. Then for this situation there are two options if all of the current real time bids are less than $2.00 for the current impression. First, conventionally the bids would all be rejected because they are below the minimum goal e-CPM. However, in accordance with an embodiment of the present invention, the auction process may still continue by filtering out bids that would not maintain the average e-CPM at least equal to the goal e-CPM.

In one embodiment a second bid filtering module 430 filters out bids if they do not satisfy the floor e-CPM value. Suppose that the average e-CPM is $2.50, the goal e-CPM is $2, and the minimum e-CPM is $1.70. In this situation, a current bid of $1.75 is not filtered out by the floor value. If this current bid will not reduce the average e-CPM below $2 (and satisfies any other rules of the auction) it is acceptable to increase fill rate and total revenue.

One aspect of this approach is that there is fine granular control of the filtering process. Each time an ad request is made, the current average e-CPM is computed, factoring in the current bid. If a bid value would reduce the current paid e-CPM to a value lower than the goal, the bid will be rejected.

Additionally, another aspect is that there is a minimum floor value below for which no bid value will be accepted that can be adapted based on supply and demand patterns and other factors. Additionally, the floor value can be tiered based on number of impressions or other factors. For example, the minimum value may be selected based on historical data and adjusted over time based on supply and demand patterns so that the average e-CPM will not drop too early in a specified time interval in order to avoid rejecting higher valued bids and campaigns later in the specified time interval.

Data mining 215 and machine learning 220 may, for example, detect long term, medium term, or short term trends in supply and demand to determine adjustments to the floor e-CPM to optimize revenue or other goals. For example, in a particular geographic area, supply and demand patterns may be correlated with time of day, day of the week, or other variables. For example, suppose that there is a pattern that there is more demand, relative to supply, from advertisers on weekends for particular demographic (e.g., the advertisers may target consumers during their free time on weekends). In this situation suppose demand is low on a Friday afternoon such that all of the bids for an ad segment are below the goal e-CPM. There may also be data on current trends for the bid values, in additional to historical data. The data on temporal patterns and predicted and actual supply and demand may indicate that it is likely that bidding values will increase the next day. Statistical techniques or other modeling techniques may be used to determine optimum floor e-CPM values when the bid values are below the goal e-CPM. For example, if the floor value is chosen too low when bidding values are below the goal e-CPM, the average e-CPM may drop too early in the campaign. To safely optimize revenue and safely achieve the goal e-CPM for the campaign may require the floor e-CPM value to be dynamically varied over time.

The minimum floor e-CPM may be adjusted frequently based on predicted and actual supply and demand patterns to safely optimize the different campaign objectives. Additionally, the frequency of the adjustment and the range of each adjustment may be based on historical patterns. Data analysis may be used to adjust the minimum floor value by taking into account the current average e-CPM, length of the campaign, and data trends that may change bidding values for different time periods of interest in the future. That is, historical data and supply and demand patterns may be used to adjust the floor e-CPM to optimize the objective of safely maintaining the average e-CPM at least equal to the goal e-CPM while achieving other objectives, such as optimizing fill rate and revenue.

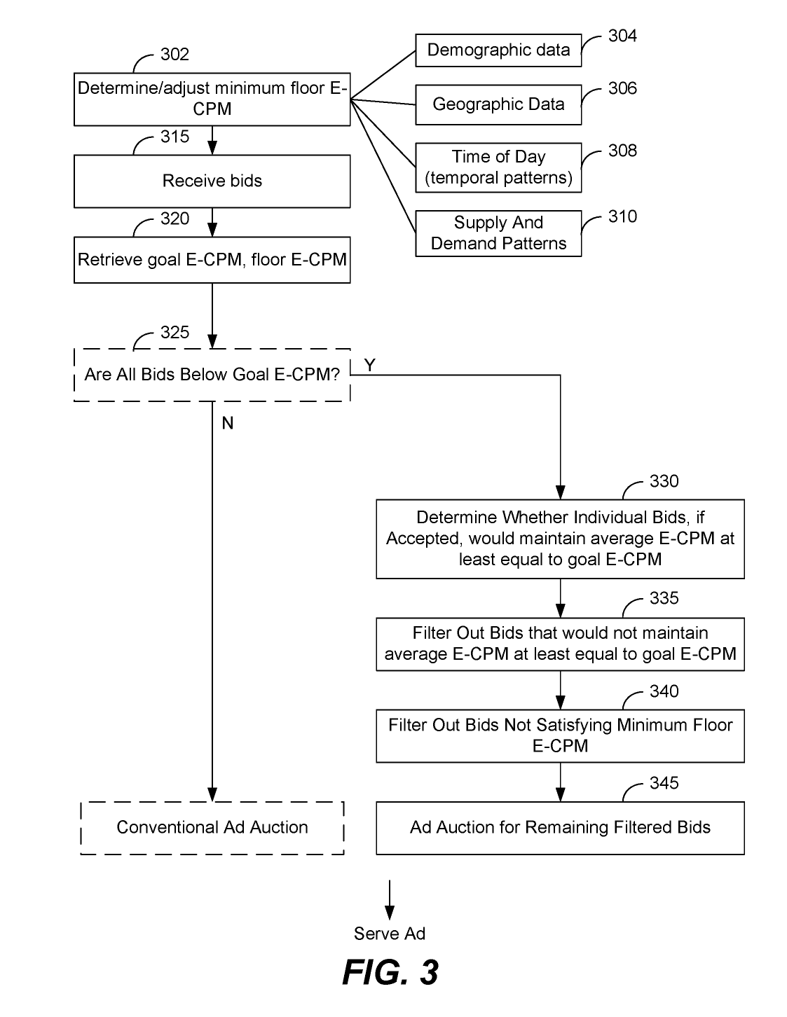

FIG. 3 illustrates an exemplary method in accordance with an embodiment of the present invention. A minimum floor e-CPM is determined in block 302. While a fixed value could be set, in the most general case, the minimum floor e-CPM may be frequently adjusted over time based on factors, such as demographic data 304, geographic data 306, and time of day 308. Additionally the minimum floor e-CPM may be adjusted based on supply and demand factors 310. For example, historical data on supply and demand as well as recent supply and demand determinations may be used to adjust the floor e-CPM.

Bids are received in block 315. The goal e-CPM and minimum e-CPM is retrieved in block 320. A decision is made in block 325 if the bids are above the goal e-CPM, in which case a conventional auction process may be conducted.

However, if all of the bids are below the goal e-CPM then a determination is made in block 330 whether an individual bid would maintain the average e-CPM at least equal to the goal e-CPM. Bits that would not maintain the average e-CPM at least equal to the goal e-CPM are filtered out in block 335. Additionally, bids are filtered out in block 340 that do not satisfy the minimum floor e-CPM in block 345. The ad auction is then conducted for any remaining filtered bids in block 345. The corresponding ad for the selected bid is then served.

It will be understood that variations on the method of FIG. 3 are contemplated. For example, filtering could always be employed, even if some of the bids are above the goal e-CPM. Additionally, the order in which filtering of bids if performed may vary. For example, filtering based on the floor e-CPM 340 could be performed before filtering on the average e-CPM 335.

The present invention provides a substantial benefit over the prior art. In the prior art the e-CPM goal was used as a hard floor such that all bids were rejected below the e-CPM goal. This has the downside that the fill rate and revenue is lower than desired. In contrast, tests of the present invention have demonstrated a 30% improvement in fill rate and revenue in some implementations.

These examples and embodiments are provided solely to add context and aid in the understanding of the invention. Thus, it will be apparent to one skilled in the art that the present invention may be practiced without some or all of the specific details described herein. In other instances, well-known concepts have not been described in detail in order to avoid unnecessarily obscuring the present invention. Other applications and examples are possible, such that the following examples, illustrations, and contexts should not be taken as definitive or limiting either in scope or setting. Although these embodiments are described in sufficient detail to enable one skilled in the art to practice the invention, these examples, illustrations, and contexts are not limiting, and other embodiments may be used and changes may be made without departing from the spirit and scope of the invention.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

Although illustrative embodiments and applications of this invention are shown and described herein, many variations and modifications are possible which remain within the concept, scope, and spirit of the invention, and these variations would become clear to those of ordinary skill in the art after perusal of this application. Accordingly, the embodiments described are to be considered as illustrative and not restrictive, and the invention is not to be limited to the details given herein, but may be modified within the scope and equivalents of the appended claims.

1. A method for an ad server to serve an ad to an ad segment on a Web page being viewed by a user, said Web page published by a publisher, the method comprising:
receiving a minimum goal effective cost per mil (e-CPM) for an advertising campaign in which a bidding process occurs for individual ad segments;
tracking an average effective cost per mil (e-CPM) over a total number of impressions served during the advertising campaign; and
adjusting a short term e-CPM of acceptable winning bids to include bids below the minimum goal e-CPM, including:
for an individual ad segment, determining a floor effective cost per mil (e-CPM) bid value;
retrieving the minimum goal e-CPM for paid impressions;
determining a current average e-CPM for the total number of previous impressions at the time the individual ad segment is received;
initiating a bidding process with two or more ad serving entities for the ad segment;
receiving bids for the ad segment;
filtering out bids having a bid value for the ad segment that would, if accepted, result in the average e-CPM becoming less than the minimum goal e-CPM;
filtering out bids that are less than the floor e-CPM;
selecting one of the remaining unfiltered current bids, based on auction criteria, to serve an ad to the Web page of the user,
wherein the floor e-CPM is determined, based on supply and demand patterns indicative of likely future bidding values, to increase fill rate during periods of low demand by accepting bids lower than the goal e-CPM, and prevent the average e-CPM prematurely dropping in a specified time period in which bidding values are expected to rise;
wherein the goal e-CPM is set by a publisher;
wherein the floor e-CPM is determined based at least in part on the location of the user;
wherein the floor e-CPM is based at least in part on the demographics of the user;
and wherein the floor e-CPM is adjusted over time based on at least one of: 1) temporal patterns and 2) supply and demand patterns.

2. The method of claim 1, wherein the floor e-CMP is dynamically adjusted over a sequence of served impressions to control decay characteristics of the average e-CPM during periods of low demand when all bids are below the minimum goal e-CPM; and
wherein the floor e-CPM is determined, based on supply and demand patterns indicative of likely future bidding values, to increase fill rate during periods of low demand by accepting bids lower than the minimum goal e-CPM, and preventing the average e-CPM prematurely dropping in a specified time period in which bidding values are expected to rise.

3. A system to serve an ad to an ad segment on a Web page being viewed by a user, said Web page published by a publisher, comprising:
an ad server communicatively coupled to a plurality of ad networks, the ad server including:
a processor and a memory;
a data mining unit;
a machine learning unit;
an effective cost per mil (e-CPM) floor determination unit to determine a floor e-CPM based on the determined supply and demand trends;
an e-CPM goal unit to determine an e-CPM goal;
an average e-CPM unit to determine an average e-CPM during the advertising campaign over a total number of previous impressions and determine whether a candidate bid for a current impression would, if accepted, reduce the average e-CPM below the goal e-CPM;
wherein the ad server is configured to:
determine demographic, geographic, and time of day associated with a user viewing a Web page containing the ad segment;
determine a floor e-CPM for the ad segment based at least in part on the supply and demand trends determined by the data mining unit and the machine learning unit;
initiate a bidding process with a plurality of ad serving entities for the ad segment and receive candidate bids;
retrieve a current average effective cost per mil (e-CPM) based on impressions served in the past for a selected time window of an advertising campaign;
perform an ad auction if any of the candidate bids are at least equal to the minimum goal e-CPM; and
perform a modified ad auction if all of the candidate bids are below the minimum goal e-CPM to increase fill rate, including: 1) rejecting any candidate bid for the ad segment that would, if accepted, result in the average e-CPM becoming less than the goal e-CPM; and 2) rejecting any candidate bid that is less than the floor e-CPM, wherein the floor e-CPM is selected, based on supply and demand trends, to control the decay characteristics of the average e-CPM; and
serve an ad corresponding to a selected candidate bid to the Web page on the user computer;
wherein the system is configured to dynamically adjust the floor e-CPM over a sequence of served impressions to control decay characteristics of the average e-CPM during periods of low demand when all bids are below the minimum goal e-CPM; and
wherein the floor e-CPM is determined, based on supply and demand patterns indicative of likely future bidding values, to increase fill rate during periods of low demand by accepting bids lower than the goal e-CPM, and prevent the average e-CPM prematurely dropping in a specified time period in which bidding values are expected to rise; and
wherein the floor e-CPM is determined based on the supply and demand patterns and at least one of temporal patterns, geographic data, and demographic data.

4. A method for an ad server to serve an ad to an ad segment on a Web page being viewed by a user, said Web page published by a publisher, the method comprising:
receiving a minimum goal effective cost per mil (e-CPM) for an advertising campaign in which a bidding process occurs for individual ad segments;
tracking an average effective cost per mil (e-CPM) over a total number of impressions served during the advertising campaign; and
adjusting a short term e-CPM of acceptable winning bids to include bids below the minimum goal e-CPM, including:
for an individual ad segment, determining a floor effective cost per mil (e-CPM) bid value;
retrieving the minimum goal e-CPM for paid impressions;
initiating a bidding process with two or more ad serving entities for the ad segment;
receiving bids for the ad segment;
filtering out bids having a bid value for the ad segment that would, if accepted, result in the average e-CPM becoming less than the minimum goal e-CPM;
filtering out bids that are less than the floor e-CPM;
selecting one of the remaining unfiltered current bids, based on auction criteria, to serve an ad to the Web page of the user; and
wherein the floor e-CPM is determined, based on supply and demand patterns indicative of likely future bidding values, to increase fill rate during periods of low demand by accepting bids lower than the goal e-CPM, and prevent the average e-CPM prematurely dropping in a specified time period in which bidding values are expected to rise.

5. The method of claim 4, wherein the goal e-CPM is set by a publisher.

6. The method of claim 4, wherein the floor e-CPM is determined based at least in part on the location of the user.

7. The method of claim 4, wherein the floor e-CPM is based on the demographics of the user.

8. The method of claim 4, wherein the floor e-CPM is based on the time of day.

9. The method of claim 4, wherein the average e-CPM is analyzed during a campaign.

10. The method of claim 4, wherein the floor e-CPM is adjusted over time based on at least one of: 1) temporal patterns and 2) supply and demand patterns.

11. A system to serve an ad to an ad segment on a Web page being viewed by a user, said Web page published by a publisher, comprising:
an ad server communicatively coupled to a plurality of ad networks, the ad server including:
a processor and a memory;
a data mining unit in combination with a machine learning unit to determine supply and demand trends for ad segments served during an advertising campaign;
an effective cost per mil (e-CPM) floor determination unit to determine a floor e-CPM based on the determined supply and demand trends;
an e-CPM goal unit to determine an e-CPM goal;
an average e-CPM unit to determine an average e-CPM for previous impressions during the advertising campaign and determined whether a candidate bid would, if accepted, reduce the average e-CPM below the goal e-CPM;
wherein the ad server is configured to:
determine demographic, geographic, and time of day associated with a user viewing a Web page containing the ad segment;
determine a floor e-CPM for the ad segment based at least in part on the supply and demand trends determined by the data mining unit and the machine learning unit;
initiate a bidding process with a plurality of ad serving entities for the ad segment and receive candidate bids;
retrieve a current average effective cost per mil (e-CPM) based on impressions served in the past for a selected time window of an advertising campaign;
perform an ad auction if any of the candidate bids are at least equal to the minimum goal e-CPM; and
perform a modified ad auction if all of the candidate bids are below the minimum goal e-CPM to increase fill rate, including: 1) rejecting any candidate bid for the ad segment that would, if accepted, result in the average e-CPM becoming less than the goal e-CPM; and 2) rejecting any candidate bid that is less than the floor e-CPM, wherein the floor e-CPM is selected, based on supply and demand trends, to control the decay characteristics of the average e-CPM; and
serve an ad corresponding to a selected candidate bid to the Web page on the user computer;
wherein the system is configured to dynamically adjust the floor e-CPM over a sequence of served impressions to control decay characteristics of the average e-CPM during periods of low demand when all bids are below the minimum goal e-CPM; and
wherein the floor e-CPM is determined, based on supply and demand patterns indicative of likely future bidding values, to increase fill rate during periods of low demand by accepting bids lower than the goal e-CPM, and prevent the average e-CPM prematurely dropping in a specified time period in which bidding values are expected to rise.

12. The system of claim 11, wherein the floor e-CPM is determined based on the supply and demand patterns and at least one of temporal patterns, geographic data, and demographic data.
